(19) United States
(12) Patent Application Publication
(10) Pub. No.: US 2024/0132676 A1
(43) Pub. Date: Apr. 25, 2024

(54) SULFONATED LIGNIN AS A BY-PRODUCT OF PAPERMAKING WOOD PULP/UREA-FORMALDEHYDE FERTILIZER AND METHOD FOR PREPARING THE SAME BY A REACTIVE EXTRUSION AND GRANULATION PROCESS

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Peng GAO, Taiyuan (CN); Chaoyang WU, Taiyuan (CN); Guizhe ZHAO, Taiyuan (CN)

(21) Appl. No.: 18/542,483

(22) Filed: Dec. 15, 2023

Related U.S. Application Data
(63) Continuation of application No. PCT/CN2023/088613, filed on Apr. 17, 2023.

(30) Foreign Application Priority Data
Mar. 14, 2023 (CN) 202310237417.9

(51) Int. Cl. C08H 7/00; C05F 9/00

(52) U.S. Cl. CPC C08H 6/00; C05F 9/00

(57) ABSTRACT

A sulfonated lignin as a by-product of papermaking wood pulp/urea-formaldehyde (UF) fertilizer and a method for preparing the same by a reactive extrusion and granulation process are provided. The method includes: mixing a hydroxymethylated sulfonated lignin solution with a hydroxymethyl-urea solution followed by feeding into a reaction-extrusion integrated machine and reaction at a preset temperature for a preset time; subjecting the reaction mixture to extrusion through a twin-screw extruder to obtain a strip product; and drying the strip product followed by granulation to obtain a sulfonated lignin as a by-product of papermaking wood pulp/UF fertilizer columnar particles. Sulfonated lignin molecules are introduced to the main chain of the UF macromolecules to reduce the polymerization degree and crystallinity of the UF fertilizer, so as to regulate the nitrogen release rate.

### CROSS-REFERENCE TO RELATED APPLICATIONS

This application is a continuation of International Patent Application No. PCT/CN2023/088613, filed on Apr. 17, 2023, which claims the benefit of priority from Chinese Patent Application No. 202310237417.9, filed on Mar. 14, 2023. The content of the aforementioned application, including any intervening amendments thereto, is incorporated herein by reference in its entirety.

### TECHNICAL FIELD

This application relates to urea-formaldehyde (UF) slow- and controlled-release fertilizers, in particular to a sulfonated lignin as a by-product of papermaking wood pulp/UF fertilizer and a method for preparing the same by a reactive extrusion and granulation process.

### BACKGROUND

Currently, the increase in grain yield is mainly achieved through the application of chemical fertilizers. Among them, urea is the most widely used nitrogen fertilizer. However, due to the high water solubility, about 40-70% of nitrogen in urea cannot be absorbed by plants, and the loss of this part of nitrogen may cause ecological and environmental safety problems, such as water eutrophication and soil acidification. The development of slow- and controlled-release fertilizers is an effective way to improve nutrient utilization. These fertilizers have a slow nutrient release rate and a long release period and can meet the nutrient demand of crops throughout the growth period. Urea-formaldehyde (UF) slow-release fertilizer has been widely used for its long-lasting stability, high utilization rate, and less environmental pollution. However, the excessively long release period makes UF fertilizer unsuitable for short-duration crops such as vegetables and grains. In addition, most research reports and industrial production of UF fertilizer are prepared in a liquid phase, which makes the process difficult to control, thereby leading to too fast polymerization and poor processibility. This preparation process also has a high cost, complex and cumbersome operation, and serious dust pollution.

Lignin is a complex natural organic polymer compound existing in the xylogen components of most plants and is one of the main components constituting the plant skeleton. According to statistics, as much as 150 billion tons of lignin can be produced annually by all plants worldwide. Lignin has a complex molecular structure, which has not been completely understood so far, and different extraction and separation solutions will bring structurally different lignin products, greatly limiting the application of lignin. Lignin is a precursor of soil humus, which can inhibit the soil urease activity and thus slow down the nutrient release. In view of this, lignin is considered an ideal material for the preparation of slow-release fertilizers. Lignin can be obtained through various pulping processes, but only sulfonated lignin can be obtained in large quantities. At present, about 95% of sulfonated lignin is discharged as waste in the processes of paper making, textile, and pulp making, causing pollution to the environment while wasting resources. Paper-making waste liquid is the main source of sulfonated lignin, and an effective recycling approach can not only satisfy the demand for sulfonated lignin but also address the related environmental pollution problems.

Lignin contains a variety of functional groups, such as carbonyl, hydroxyl, aromatic ring, methoxy, and carboxyl. As one of the characteristic functional groups of lignin, methoxy occupies most of the active sites in lignin (e.g., ortho and para positions of phenolic hydroxyl), and the severe steric hindrance greatly reduces the activity of lignin. But under alkaline conditions, lignin will undergo a hydroxymethylation reaction to produce hydroxymethylated lignin. Specifically, under alkaline conditions, the hydrogen of the phenolic hydroxyl is removed so that the electrons of the oxygen are delocalized to the benzene ring to form a resonance system, thereby activating the ortho- and para-positions of the phenolic hydroxyl. The activated lignin can participate in the polycondensation reaction of UF resin.

Reactive extrusion has become an emerging polymer molding technology in recent years, in which the polymerization process and processing process are combined, and the chemical reaction and the continuous production are carried out simultaneously in the processing machinery. Regarding the reactive extrusion, an extruder is used as the reaction vessel, and a plasticization-extrusion system composed of a screw and a barrel is used as the continuous reactor. Various raw material components, such as monomers, initiators, polymers, and additives are fed to the barrel from the same or different ports at one time or in batches and then are mixed, conveyed, plasticized, reacted, and extruded from the die under the rotation of the screw. The reactive extrusion can achieve continuous industrial production and has low investment and cost, no or little consumption of solvents harmful to the human body and environment, excellent compatibility for products and raw materials, high reaction efficiency, and uniform product performance. Moreover, the processes of devolatilization of polymers, granulation, and molding are simplified, exhibiting a brilliant application prospect.

### SUMMARY

In view of the deficiencies in the prior art, this application provides a sulfonated lignin as a by-product of papermaking wood pulp/urea-formaldehyde (UF) fertilizer and a method for preparing the same by a reactive extrusion and granulation process.

The technical solutions of this application will be described as follows.

In a first aspect, this application provides a sulfonated lignin as a by-product of papermaking wood pulp/urea-formaldehyde (UF) fertilizer, which has structures represented by:

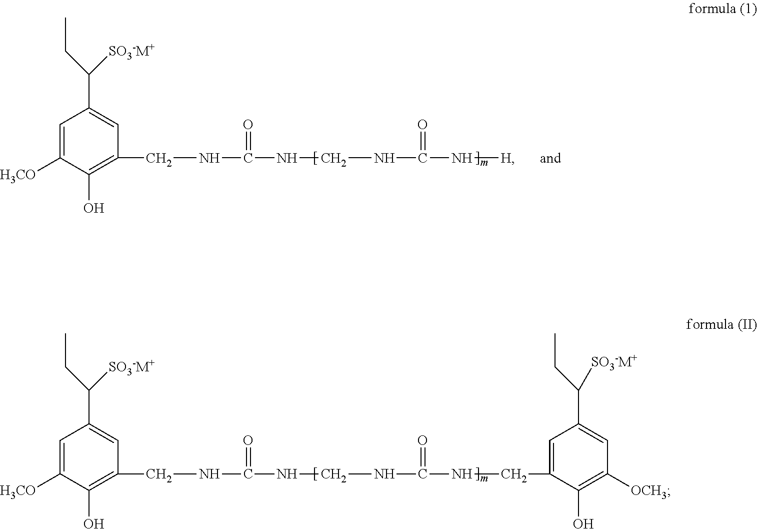

wherein M⁺ is K⁺, Na⁺, or NH₄⁺; and m is selected from 1-5.

This application further provides a method of preparing the sulfonated lignin as a by-product of papermaking wood pulp/UF fertilizer, comprising:
(1) adding formaldehyde, sulfonated lignin, and water to a first reactor to obtain a first mixture, and adjusting a pH of the first mixture followed by a reaction to obtain a hydroxymethylated sulfonated lignin solution;
(2) sequentially adding formaldehyde and urea to a second reactor to obtain a second mixture; and adjusting a pH of the second mixture followed by a reaction to obtain a hydroxymethyl-urea solution;
(3) sealing a die opening between a reaction unit and an extrusion unit of a reaction-extrusion integrated machine; mixing the hydroxymethylated sulfonated lignin solution obtained in steps (1) and the hydroxymethyl-urea solution obtained in step (2) to obtain a third mixture; and adjusting a pH of the third mixture followed by feeding to a twin-screw reaction extruder of the reaction unit of the reaction-extrusion integrated machine;
(4) turning on a screw of the twin-screw reaction extruder, and simultaneously starting a vacuumization-de-volatilization device of the twin-screw reaction extruder to remove water from the third mixture; and reacting the third mixture at a preset temperature and a preset screw rotation speed for a preset time to obtain a viscous reaction product;
(5) opening the die opening between the reaction unit and the extrusion unit, and starting a twin-screw extruder of the extrusion unit such that the viscous reaction product obtained in step (4) is conveyed by the twin-screw reaction extruder of the reaction unit to the twin-screw extruder of the extrusion unit; and subjecting the viscous reaction product to extrusion at a preset temperature and a preset screw rotation speed to obtain a strip product; and
(6) drying the strip product obtained in step (5) at a preset temperature followed by granulation to obtain the sulfonated lignin as a by-product of papermaking wood pulp/UF fertilizer in a form of a columnar particle.

In some embodiments, in step (1), a molar ratio of the formaldehyde to the sulfonated lignin is 1.1˜1.7:1, and a weight ratio of the sulfonated lignin to the water is 6:7; the first mixture is adjusted to pH 10˜14; and the reaction is performed at 40° C.˜70° C. for 1˜2 h.

In some embodiments, in step (2), a molar ratio of urea to formaldehyde is 1˜2:1; the second mixture is adjusted to pH 8˜10; and the reaction temperature is performed at 40° C.˜80° C. for 1˜2 h.

In some embodiments, in step (3), a weight ratio of hydroxymethyl-urea in the hydroxymethyl-urea solution to hydroxymethylated sulfonated lignin in the hydroxymethylated sulfonated lignin solution is 1˜9:1, and the third mixture is adjusted to pH 3˜5.

In some embodiments, in step (4), the preset temperature is 80° C.˜120° C.; the preset time is 20˜50 min; and the preset screw rotation speed is 10˜50 rpm.

In some embodiments, in step (5), the preset temperature is 80° C.˜120° C.; and the preset screw rotation speed is 10˜50 rpm.

In some embodiments, in step (6), the preset temperature for drying the strip product is 40° C.˜120° C.

In some embodiments, a sulfonated lignin molecule is introduced to a main chain of a UF macromolecule to reduce the polymerization degree and crystallinity of the UF fertilizer so as to regulate a nitrogen nutrient release rate of the UF fertilizer; and a benzene ring in the sulfonated lignin molecule makes the sulfonated lignin/UF fertilizer have an high compressive strength.

Compared to the existing fertilizers, this application has the following beneficial effects.
(1) Regarding the sulfonated lignin/UF biodegradable slow-release fertilizer prepared herein, sulfonated lignin molecules are introduced to the main chain of UF macromolecules to reduce the polymerization degree and crystallinity of UF fertilizer, so as to regulate the nitrogen release rate thereby overcoming the shortcomings that the traditional UF fertilizers are not suitable for short- and medium-duration crops such as vegetables and grains. Therefore, the UF fertilizer provided herein has a wider application range.
(2) In the prior art, the granulation process of UF fertilizer is performed by crude crushing granulating method, which will result in serious dust pollution and poor uniformity in particle shape and size. This application adopts a continuous and efficient in-situ reactive extrusion and granulation method, by which the sulfonated lignin/UF fertilizer particles can be continuously prepared. Compared to the existing process and method of preparing UF fertilizer particles, the present application has the advantages of a simple process, no dust pollution, continuous production, and less labor and material consumption. In particular, it can solve the problem that the existing UF fertilizers are mainly applied to high-value crops due to high cost.
(3) Compared with traditional UF fertilizers, the application introduces readily available and cheap sulfonated lignin (a by-product of papermaking wood pulp), which not only can further reduce the preparation cost of the UF fertilizer particles, but also can significantly improve the mechanical properties of the UF fertilizer particles, thus facilitating the subsequent storage, transportation, and application. In addition, this application enables the recycling of papermaking by-products.
(4) The sulfonated lignin/UF biological slow-release fertilizer prepared by this application can be gradually degraded and hydrolyzed into small-molecule nutrients under the action of microorganisms and water after being applied into the soil, which can reduce the fixation of nutrient elements by the soil and avoid harmful substance residue. Therefore, the sulfonated lignin/UF fertilizer is green and environmentally friendly.
(5) The sulfonated lignin in the sulfonated lignin/UF biodegradable slow-release fertilizer prepared herein is a precursor of soil humus, which can improve soil physicochemical properties and enhance soil fertility.

### BRIEF DESCRIPTION OF THE DRAWINGS

The accompanying drawings are incorporated and constitute a part of the specification, and the embodiments illustrated therein together with the specification are used to explain the principles of the present application.

In order to illustrate the technical solutions in the embodiments of the present application or prior art more clearly, the accompanying drawings needed in the description of the embodiments of the present application or the prior art will be briefly described below. It is apparent that one of ordinary skill in art can obtain other drawings based on the drawings provided herein without making a creative effort.

FIG. 1 shows the infrared (IR) spectra of sulfonated lignin before and after hydroxymethylation.

FIG. 2 shows the infrared spectra of a sulfonated lignin as a by-product of papermaking wood pulp/UF fertilizer prepared in Example 1, a UF slow-release fertilizer without sulfonated lignin prepared in Comparative Example 1, and a physical mixture of sulfonated lignin and UF slow-release fertilizer prepared in Comparative Example 2.

FIG. 3 shows the thermogravimetric spectra of the sulfonated lignin as a by-product of papermaking wood pulp/UF fertilizer prepared in Example 1, the UF slow-release fertilizer without sulfonated lignin prepared in Comparative Example 1, and the physical mixture of sulfonated lignin and UF slow-release fertilizer prepared in Comparative Example 2.

FIG. 4 shows the differential thermogravimetric curves of the sulfonated lignin as a by-product of papermaking wood pulp/UF fertilizer prepared in Example 1, the UF slow-release fertilizer without sulfonated lignin prepared in Comparative Example 1, and the physical mixture of sulfonated lignin and UF slow-release fertilizer prepared in Comparative Example 2.

FIG. 5 shows the X-ray diffraction (XRD) patterns of the sulfonated lignin as a by-product of papermaking wood pulp/UF fertilizer prepared in Example 1, the UF slow-release fertilizer without sulfonated lignin prepared in Comparative Example 1, and the physical mixture of sulfonated lignin and UF slow-release fertilizer prepared in Comparative Example 2.

FIG. 6 shows the compressive strength test curves of the sulfonated lignin as a by-product of papermaking wood pulp/UF fertilizer prepared in Example 1 and the UF slow-release fertilizer without sulfonated lignin prepared in Comparative Example 1.

FIG. 7 shows the hydrostatic nitrogen release curves of the sulfonated lignin as a by-product of papermaking wood pulp/UF fertilizer prepared in Example 1 and the UF slow-release fertilizer without sulfonated lignin prepared in Comparative Example 1.

### DETAILED DESCRIPTION OF EMBODIMENTS

The present application will be described in detail below with reference to the embodiments and accompanying drawings to promote the understanding of the objects, features, and advantages of the present application. It is to be noted that the embodiments of the present application and the features therein may be combined with each other in the case of no contradiction.

The performance testing and characterization adopted herein are performed based on the criteria below.
(1) The cylindrical fertilizer particles are ground and crushed, and sieved with a 0.25 μm sieve to obtain the test sample powder. A small amount of the dried powder is pressed with KBr to prepare samples for infrared (IR) analysis, and the IR analysis is performed at room temperature by using a Nicolet IS50 infrared spectrometer with a scanning range of 500˜4000 cm⁻¹. The X-ray diffraction analysis is performed using an X-ray diffractometer (HAOYUAN DX-2700B, Haoyuan Instrument Co., Ltd, Dandong City, Liaoning Province, China) with a scanning range of 5-80°. The thermal stability of samples is measured under a nitrogen atmosphere using a thermogravimetric analyzer (TA Q50) with a temperature range of 30-800° C., a heating rate of 10° C./min, and a nitrogen flow rate of 40 mL/min.
(2) The compressive strength test is performed using a universal testing machine MTS CMT 5105. The columnar particles are placed on the testing machine and compressed in the longitudinal direction with a pressure of 20000 kgf and a compression rate of 5 mm/min, and the test is completed until 40% of the maximum deformation is reached.
(3) The slow-release performance of nitrogen nutrient is characterized by a hydrostatic release test. 5.00 g of fertilizer particles are weighed, packed, and sealed in a mesh bag, placed in a bottle containing 100 mL of deionized water, and sampled respectively at 1, 3, 5, 7, 10, 14, 28, 42, and 56 d. When taking samples, the bottle is turned upside down to render the solution even. 20 mL of the solution is taken and determined for the nitrogen content using sulfuric acid-hydrogen peroxide digestion and the Kjeldahl method to calculate the cumulative release rate of N nutrient.

The present application provides a sulfonated lignin as a by-product of papermaking wood pulp/UF fertilizer compound, which is represented by:

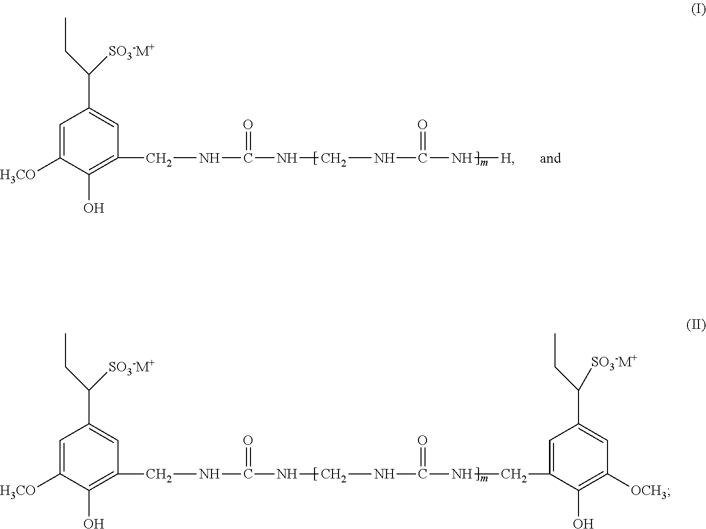

where M⁺ is K⁺, Na⁺, or NH₄⁺; and m is selected from 1-5.

The present application further provides a method for preparing the sulfonated lignin as a by-product of papermaking wood pulp/UF fertilizer compound by a reactive extrusion and granulation process, including the following steps.
(1) Formaldehyde, sulfonated lignin, and water are added to a first reactor to obtain a first mixture. The first mixture is subjected to pH adjustment and reacted to obtain a hydroxymethylated sulfonated lignin solution.
(2) Formaldehyde and urea are added to a second reactor to obtain a second mixture, which is subjected to pH adjustment and reacted to obtain a hydroxymethyl-urea solution. (3) A die opening between the reaction unit and the extrusion unit of a reaction-extrusion integrated machine is sealed, and the solutions obtained in steps (1) and (2) are mixed to obtain a third mixture, which is then subjected to pH adjustment, and fed into the twin-screw reaction extruder of the reaction unit.
(4) A screw of the twin-screw reaction extruder of the reaction unit is turned on, and a vacuumization-de-volatilization device of the twin-screw reaction extruder of the reaction unit is started simultaneously to remove the water from the third mixture. The third mixture is reacted at a preset temperature and a preset screw rotation speed for a preset time.
(5) The die opening between the reaction unit and the extrusion unit is opened, and the twin-screw extruder of the extrusion unit is started, such that the viscous reaction product obtained in step (4) is conveyed by the twin-screw reaction extruder of the reaction unit to the twin-screw extruder of the extrusion unit. The viscous reaction product is subjected to extrusion at a preset temperature and a preset screw rotation speed to obtain a strip product.
(6) The strip product obtained in step (5) is dried at a preset temperature and granulated to obtain the sulfonated lignin/UF fertilizer in a form of a columnar particle.

The reaction mechanism of the preparation of the sulfonated lignin as a by-product of papermaking wood pulp/UF fertilizer is schematically illustrated as follows:

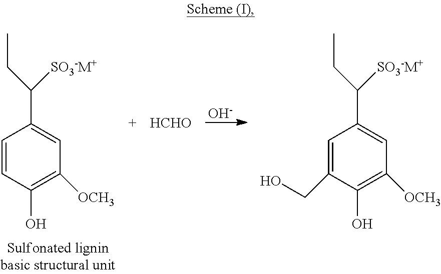

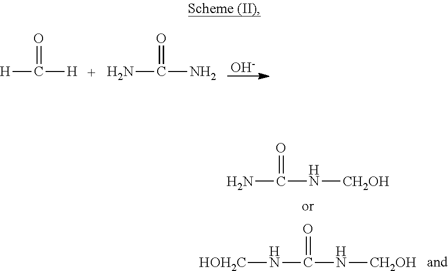

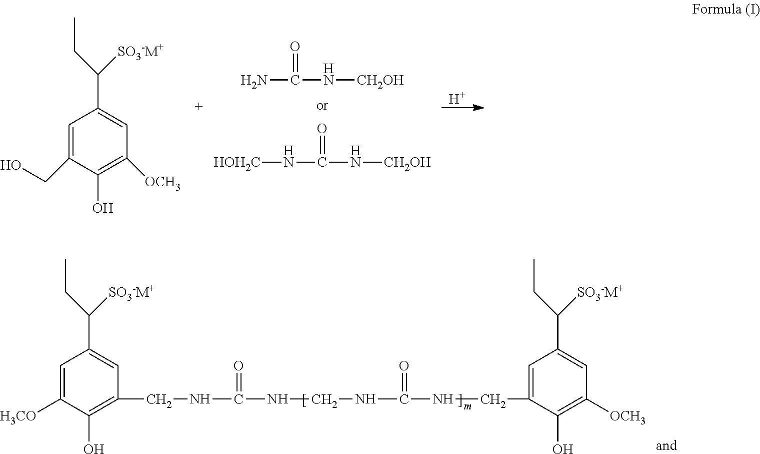

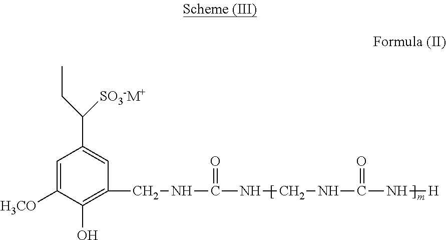

where M⁺ is K⁺, Na⁺, or NH₄⁺; and m is selected from 1-5; and the reaction in step (1) is illustrated in the Scheme (I); the reaction in step (2) is illustrated in the Scheme (II); and the reaction in step (4) is illustrated in the Scheme (III).

The reaction-extrusion integrated machine of this application includes a reaction unit and an extrusion unit. The twin-screw reaction extruder of the reaction unit and the twin-screw extruder of the extrusion unit are both known in the art to which this application pertains, where a discharging die opening of the twin-screw reaction extruder is communicated with the feeding die opening of the twin-screw extruder; and the vacuumization-de-volatilization device is a part of the twin-screw reaction extruder, and is connected to the main body of the twin-screw reaction extruder in a known way in the field.

In one embodiment, in step (1), a molar ratio of the formaldehyde to the sulfonated lignin is 1.1˜1.7:1, and a weight ratio of the sulfonated lignin to the water is 6:7; the first mixture is adjusted to pH 10˜14; and the reaction is performed at 40° C.˜70° C. for 1˜2 h.

In one embodiment, in step (2), a molar ratio of urea to formaldehyde is 1˜2:1; the second mixture is adjusted to pH 8˜10; and the reaction is performed at 40° C.˜80° C. for 1˜2 h.

In one embodiment, in step (3), a weight ratio of hydroxymethyl-urea contained in the hydroxymethyl-urea solution to hydroxymethylation sulfonated lignin contained in the hydroxymethylated sulfonated lignin solution is 1˜9:1, and the third mixture is adjusted to pH 3˜5.

In one embodiment, in step (4), the preset temperature is 80° C.˜120° C.; the preset time is 20˜50 min; and the preset screw rotation speed is 10˜50 rpm.

In one embodiment, in step (5), the preset temperature is 80° C.˜120° C.; and the preset screw rotation speed is 10˜50 rpm. In one embodiment, in step (6), the preset dried temperature of the strip product is 40° C.˜120° C.

In one embodiment, a sulfonated lignin molecule is introduced to the main chain of the urea-formaldehyde macromolecule to reduce the polymerization degree and crystallinity of UF fertilizer, so as to regulate a nitrogen nutrient release rate of the UF fertilizer; and, a benzene ring in the sulfonated lignin molecules makes the sulfonated lignin as a by-product of papermaking wood pulp/UF fertilizer have an high compression strength.

Specific embodiments of the present application will be described in detail below.

### EXAMPLE 1

Provided herein was a method for preparing a sulfonated lignin as a by-product of papermaking wood pulp/UF fertilizer compound by a reactive extrusion and granulation process, including the following steps.
(1) Formaldehyde, sulfonated lignin, and water were added to a first reactor to obtain a first mixture, where a molar ratio of formaldehyde to sulfonated lignin was 1.4:1, and a weight ratio of sulfonated lignin to water was 6:7. The first mixture was adjusted to pH 13, and reacted at 50° C. for 80 min to obtain a hydroxymethylated sulfonated lignin solution.
(2) Urea and formaldehyde were added to a second reactor in a molar ratio of 1.1:1 to obtain a second mixture, which was adjusted to pH 8, and reacted at 40° C. for 1 h to obtain a hydroxymethyl-urea solution.
(3) A die opening between a reaction unit and an extrusion unit of a reaction-extrusion integrated machine was sealed. The hydroxymethylated sulfonated lignin solution and the hydroxymethyl-urea solution were mixed, adjusted to pH 5, and fed into a twin-screw reaction extruder of the reaction unit, where a weight ratio of hydroxymethyl-urea in the hydroxymethyl-urea solution to hydroxymethylated sulfonated lignin in the hydroxymethyl sulfonated lignin solution was 7:3.
(4) A screw of the twin-screw reaction extruder of the reaction unit was turned on, and at the same time, a vacuumization-de-volatilization device of the twin-screw reaction extruder of the reaction unit was started to remove water from the reaction system. The reaction system was reacted at 80° C. and a screw speed of 50 rpm for 30 min.
(5) The die opening between the reaction unit and the extrusion unit was opened, and a twin-screw extruder of the extrusion unit was started, such that the viscous reaction product obtained in step (4) was conveyed by the twin-screw reaction extruder of the reaction unit to the twin-screw extruder of the extrusion unit. The viscous reaction product was subjected to extrusion at 80° C. and a screw speed of 50 rpm to obtain a strip product.
(6) The strip product obtained in step (5) was dried at 100° C. and granulated to obtain sulfonated lignin as a by-product of papermaking wood pulp/UF fertilizer columnar particles.

The obtained sulfonated lignin as a by-product of papermaking wood pulp/UF fertilizer had a nitrogen content of 21.26 wt. % and an initial nitrogen release rate of 13.45%.

### Comparative Example 1

Provided herein was a method for preparing UF slow-release fertilizer without sulfonated lignin as a by-product of papermaking wood pulp, including the following steps.
(1) Urea and formaldehyde were added to a reactor in a molar ratio of 1.1:1, which was adjusted to pH 8, and reacted at 40 ° C. for 1 h to obtain a hydroxymethyl-urea solution.
(2) A die opening between a reaction unit and an extrusion unit of a reaction-extrusion integrated machine was sealed. The hydroxymethyl-urea solution obtained from step (1) was adjusted to pH 5 and fed into a twin-screw reaction extruder of the reaction unit.
(3) A screw of the twin-screw reaction extruder of the reaction unit was turned on, and at the same time, a vacuumization-de-volatilization device thereof was started to remove water from the reaction system. The reaction system was reacted at 80° C. and a screw speed of 50 rpm for 30 min.
(4) The die opening between the reaction unit and the extrusion unit was opened, and a twin-screw extruder of the extrusion unit was started, such that the viscous reaction product obtained in step (3) was conveyed by the twin-screw reaction extruder of the reaction unit to the twin-screw extruder of the extrusion unit. The viscous reaction product was subjected to extrusion at 80° C. and a screw speed of 50 rpm to obtain a strip product.
(5) The strip product obtained in step (4) was dried at 100° C. and granulated to obtain UF fertilizer columnar particles without sulfonated lignin.

The obtained UF fertilizer columnar particles without sulfonated lignin had a nitrogen content of 31.62 wt. % and an initial nitrogen release rate of 25.62%.

### Comparative Example 2

Provided herein was a method for preparing a physical mixture of sulfonated lignin as a by-product of papermaking wood pulp and UF slow-release fertilizer, including the following steps.
(1) Formaldehyde, sulfonated lignin, and water were added to a first reactor to obtain a first mixture, where a molar ratio of formaldehyde to sulfonated lignin was 1.4:1, and a weight ratio of sulfonated lignin to water was 6:7. The first mixture was adjusted to pH 13, and reacted at 50° C. for 80 min to obtain a hydroxymethylated sulfonated lignin solution.
(2) Step (2) was the same as the step (1) of Comparative Example 1.
(3) Step (3) was the same as the step (2) of Comparative Example 1.
(4) Step (4) was the same as the step (3) of Comparative Example 1 to obtain a viscous UF slow-release fertilizer.
(5) The liquid obtained from step (1) was adjusted to pH 5, fed into the twin-screw reaction extruder of the reaction unit and mixed with the UF slow-release fertilizer at a screw speed of 50 rpm for 30 min, where a weight ratio of hydroxymethyl-urea in the hydroxymethyl-urea solution to the hydroxymethyl sulfonated lignin in the hydroxymethyl sulfonated lignin solution was 7:3.
(6) The die opening between the reaction unit and the extrusion unit was opened, and a twin-screw extruder of the extrusion unit was started, such that the viscous reaction product obtained in step (5) was conveyed by the twin-screw reaction extruder of the reaction unit to the twin-screw extruder of the extrusion unit. The viscous reaction product was subjected to extrusion at room temperature and a screw speed of 50 rpm to obtain a strip product.
(7) The strip product obtained in step (6) was dried at 100° C. and granulated to obtain a physical mixture of sulfonated lignin and UF slow-release fertilizer in the form of columnar particles.

The physical mixture of sulfonated lignin and UF slow-release fertilizer had a nitrogen content of 21.26 wt. % and an initial nitrogen release rate of 23.81%.

### EXAMPLE 2

Provided herein was a method for preparing a sulfonated lignin as a by-product of papermaking wood pulp/UF fertilizer compound by a reactive extrusion and granulation process, including the following steps.
(1) Formaldehyde, sulfonated lignin, and water were added to a first reactor to obtain a first mixture, where a molar ratio of formaldehyde to sulfonated lignin was 1.1:1 and a weight ratio of sulfonated lignin to water was 6:7. The first mixture was adjusted to pH 10, and reacted at 40° C. for 2 h to obtain a hydroxymethylated sulfonated lignin solution.
(2) Urea and formaldehyde were added to a second reactor in a molar ratio of 1.2:1 to obtain a second mixture, which was adjusted to pH 8, and reacted at 50° C. for 1 h to obtain a hydroxymethylurea solution.
(3) A die opening between a reaction unit and an extrusion unit of a reaction-extrusion integrated machine was sealed. The hydroxymethylated sulfonated lignin solution and the hydroxymethyl-urea solution were mixed, adjusted to pH 3, and fed into a twin-screw reaction extruder of the reaction unit, where a weight ratio of hydroxymethyl-urea in the hydroxymethyl-urea solution to hydroxymethylated sulfonated lignin in the hydroxymethyl sulfonated lignin solution was 9:1.
(4) A screw of the twin-screw reaction extruder of the reaction unit was turned on, and at the same time, a vacuumization-de-volatilization device of the twin-screw reaction extruder of the reaction unit was started to remove water from the reaction system. The reaction system was reacted at 80° C. and a screw speed of 10 rpm for 20 min.
(5) The die opening between the reaction unit and the extrusion unit was opened, and a twin-screw extruder of the extrusion unit was started, such that the viscous reaction product obtained in step (4) was conveyed by the twin-screw reaction extruder of the reaction unit to the twin-screw extruder of the extrusion unit. The viscous reaction product was subjected to extrusion at 80° C. and a screw speed of 10 rpm to obtain a strip product.
(6) The strip product obtained in step (5) was dried at 40° C. and granulated to obtain sulfonated lignin as a by-product of papermaking wood pulp/UF fertilizer columnar particles.

The obtained sulfonated lignin as a by-product of papermaking wood pulp/UF fertilizer had a nitrogen content of 29.36 wt. % and an initial nitrogen release rate of 19.38%.

### EXAMPLE 3

Provided herein was a method for preparing a sulfonated lignin as a by-product of papermaking wood pulp/UF fertilizer compound by a reactive extrusion and granulation process, including the following steps.
(1) Formaldehyde, sulfonated lignin, and water were added to a first reactor to obtain a first mixture, where a molar ratio of formaldehyde to sulfonated lignin was 1.7:1, and a weight ratio of sulfonated lignin to water was 6:7. The first mixture was adjusted to pH 14, and reacted at 70° C. for 1 h to obtain a hydroxymethylated sulfonated lignin solution.
(2) Urea and formaldehyde were added to a second reactor in a molar ratio of 2:1 to obtain a second mixture, which was adjusted to pH 10, and reacted at 80° C. for 2 h to obtain a hydroxymethyl-urea solution.
(3) A die opening between a reaction unit and an extrusion unit of a reaction-extrusion integrated machine was sealed. The hydroxymethylated sulfonated lignin solution and the hydroxymethyl-urea solution were mixed, adjusted to pH 5, and fed into a twin-screw reaction extruder of the reaction unit, where a weight ratio of hydroxymethyl-urea in the hydroxymethyl-urea solution to hydroxymethylated sulfonated lignin in the hydroxymethyl sulfonated lignin solution was 1:1.
(4) A screw of the twin-screw reaction extruder of the reaction unit was turned on, and at the same time, a vacuumization-de-volatilization device of the twin-screw reaction extruder of the reaction unit was started to remove water from the reaction system. The reaction system was reacted at 120° C. and a screw speed of 30 rpm for 50 min.
(5) The die opening between the reaction unit and the extrusion unit was opened, and a twin-screw extruder of the extrusion unit was started, such that the viscous reaction product obtained in step (4) was conveyed by the twin-screw reaction extruder of the reaction unit to the twin-screw extruder of the extrusion unit. The viscous reaction product was subjected to extrusion at 120° C. and a screw speed of 30 rpm to obtain a strip product.
(6) The strip product obtained in step (5) was dried at 120° C. and granulated to obtain sulfonated lignin as a by-product of papermaking wood pulp/UF fertilizer columnar particles.

The obtained sulfonated lignin as a by-product of papermaking wood pulp/UF fertilizer had a nitrogen content of 18.61 wt. % and an initial nitrogen release rate of 62.09%.

### EXAMPLE 4

Provided herein was a method for preparing a sulfonated lignin as a by-product of papermaking wood pulp/UF fertilizer compound by a reactive extrusion and granulation process, including the following steps.
(1) Formaldehyde, sulfonated lignin, and water were added to a first reactor to obtain a first mixture, where a molar ratio of formaldehyde to sulfonated lignin was 1.4:1, and a weight ratio of sulfonated lignin to water was 6:7. The first mixture was adjusted to pH 14, and reacted at 50° C. for 1 h to obtain a hydroxymethylated sulfonated lignin solution.
(2) Urea and formaldehyde were added to a second reactor in a molar ratio of 2:1 to obtain a second mixture, which was adjusted to pH 9, and reacted at 40° C. for 1 h to obtain a hydroxymethyl-urea solution.
(3) A die opening between a reaction unit and an extrusion unit of a reaction-extrusion integrated machine was sealed. The hydroxymethylated sulfonated lignin solution and the hydroxymethyl-urea solution were mixed, adjusted to pH 5, and fed into a twin-screw reaction extruder of the reaction unit, where a weight ratio of hydroxymethyl-urea in the hydroxymethyl-urea solution to hydroxymethylated sulfonated lignin in the hydroxymethylated sulfonated lignin solution was 9:1.
(4) A screw of the twin-screw reaction extruder of the reaction unit was turned on, and at the same time, a vacuumization-de-volatilization device of the twin-screw reaction extruder of the reaction unit was started to remove water from the reaction system. The reaction system was reacted at 120° C. and a screw speed of 50 rpm for 50 min.
(5) The die opening between the reaction unit and the extrusion unit was opened, and a twin-screw extruder of the extrusion unit was started, such that the viscous reaction product obtained in step (4) was conveyed by the twin-screw reaction extruder of the reaction unit to the twin-screw extruder of the extrusion unit. The viscous reaction product was subjected to extrusion at 120° C. and a screw speed of 50 rpm to obtain a strip product.
(6) The strip product obtained in step (5) was dried at 120° C. and granulated to obtain sulfonated lignin as a by-product of papermaking wood pulp/UF fertilizer columnar particles.

The obtained sulfonated lignin as a by-product of papermaking wood pulp/UF fertilizer had a nitrogen content of 32.57 wt. % and an initial nitrogen release rate of 25 78.31%.

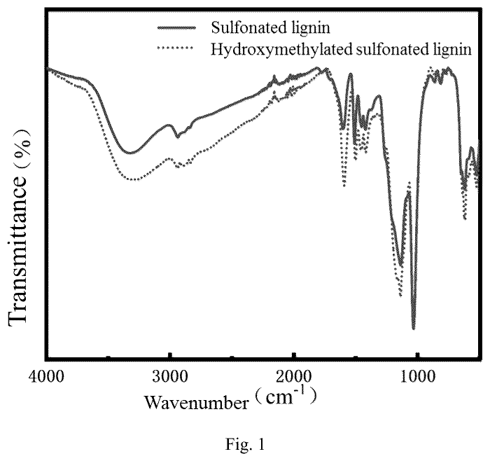

In FIG. 1, the absorption peak at 1035 cm' was attributed to the C—O stretching vibration of the phenolic compounds; the four absorption peaks at 1416, 1453, 1500, and 1590 cm⁻¹ were attributed to the C═C skeletal vibration of the benzene ring; and the absorption peak at 3300 cm⁻¹ was attributed to the stretching vibration of —OH. After normalization of all the curves at 1030 cm⁻¹, it was found that the —OH stretching vibration peak of hydroxymethylated sulfonated lignin was enhanced, indicating that the formaldehyde-modified sulfonated lignin had increased hydroxyl content and higher reactivity. The infrared analysis results indicated that the product was hydroxymethylated sulfonated lignin.

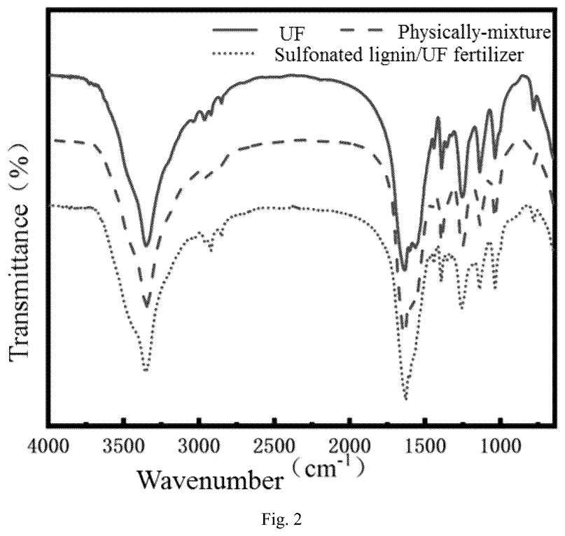

In FIG. 2, the absorption peak at 3350 cm⁻¹ was attributed to the —NH— stretching vibration, the absorption peak at 1628 cm⁻¹ was attributed to the bending vibration of —NH₂, and the absorption peak at 1650 cm⁻¹ was attributed to the bending vibration of —NH—. All curves were normalized by the bending vibration peak of —NH₂. Compared with the IR absorption peaks of the simple physical mixture of hydroxymethylated sulfonated lignin and UF, the —NH— bending vibration peak of the sulfonated lignin/UF fertilizer is significantly enhanced, indicating that the hydroxymethylated sulfonated lignin successfully reacted with UF to produce more secondary amide groups. Compared with the IR absorption peak of the UF slow-release fertilizer without sulfonated lignin, the —NH— bending vibration peak of sulfonated lignin/UF fertilizer was significantly weakened, indicating that the addition of hydroxymethylated sulfonated lignin reduced the number of amide groups in a polymeric form in the system and decreased the polymerization degree of the fertilizer, which would be more favorable to microbial degradation and increase the nutrient release rate in the middle- and later-stage of the fertilizer. The results of the infrared spectra indicate that the prepared sulfonated lignin as a by-product of papermaking wood pulp/UF fertilizer had the described structure.

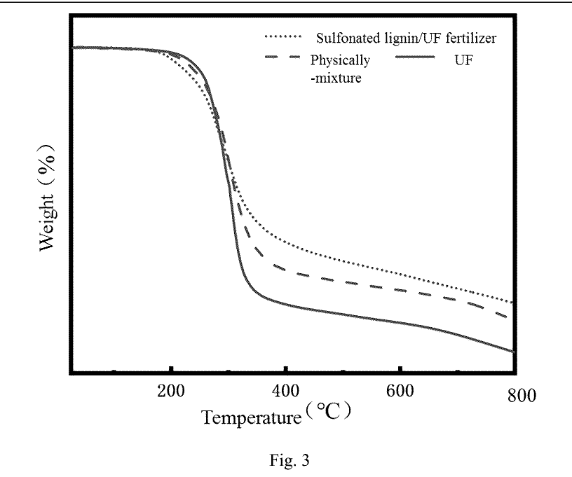

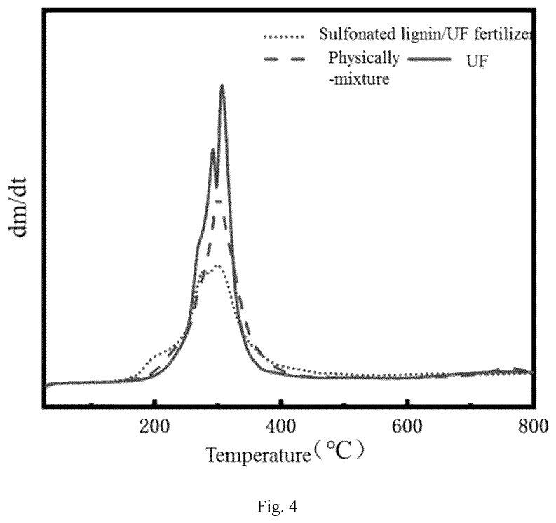

As can be seen from FIGS. 3 and 4, the thermal stability of the sulfonated lignin/UF fertilizer was higher than that of the simple physical mixture of sulfonated lignin and UF, which is due to the chemical reaction between hydroxymethylated sulfonated lignin and hydroxymethyl urea, thus improving the thermal stability. The sulfonated lignin as a by-product of papermaking wood pulp/UF fertilizer showed new pyrolysis peaks at 195° C. and 275° C. This was because the hydroxymethylated sulfonated lignin hindered the polycondensation reaction of hydroxymethyl-urea to some extent, and some UF compounds with medium and low polymerization degree, which would be beneficial to improve the nutrient release rate of the fertilizer in the middle and late stages. The thermogravimetric analysis results showed that the present method had successfully reduced the polymerization degree of the UF fertilizer.

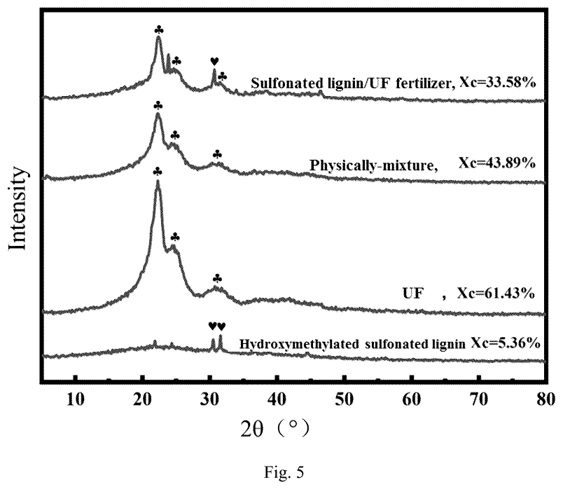

In FIG. 5, the characteristic diffraction peaks at 22.3°, 24.8°, and 31.5° were attributed to UF, and the characteristic diffraction peaks at 30.5° and 31.5° were attributed to hydroxymethylated sulfonated lignin. In the spectra of the sulfonated lignin as a by-product of papermaking wood pulp/UF fertilizer, all the above characteristic diffraction peaks appeared, indicating the successful combination of UF with hydroxymethylated sulfonated lignin. The addition of hydroxymethylated sulfonated lignin resulted in a lower crystallinity of the fertilizer, which would facilitate the degradation of the fertilizer by microorganisms and improve the nutrient release efficiency. The X-ray diffraction patterns showed that the method successfully reduced the crystallinity of UF fertilizer.

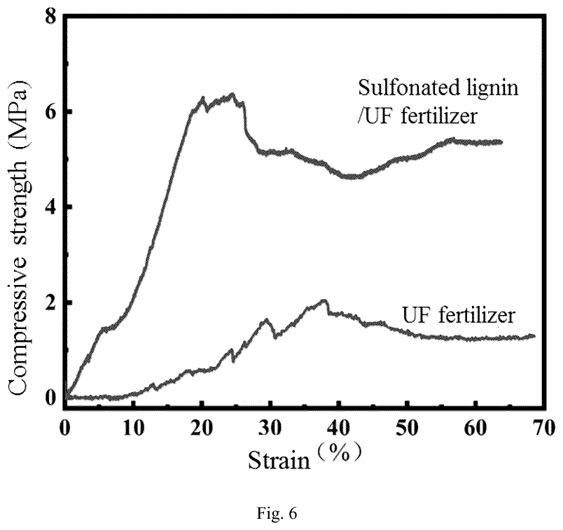

In FIG. 6, the compressive strength of the sulfonated lignin as a by-product of papermaking wood pulp/UF fertilizer was 6.37 MPa, much higher than the 2.08 MPa of the UF fertilizer, indicating that sulfonated lignin successfully participated in the polycondensation reaction of hydroxymethylurea. Since the sulfonated lignin molecule contains rigid groups such as benzene ring, the prepared fertilizer had a high compressive strength.

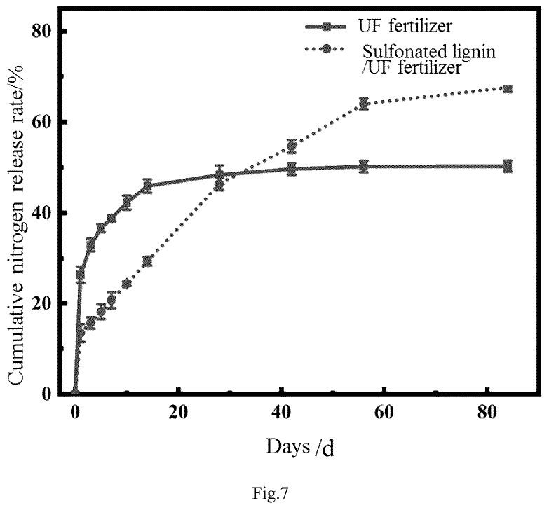

As shown in FIG. 7, the cumulative nitrogen release curve of UF fertilizer approximately presented in an inverted “L” shape, and the release period could be roughly divided into two stages, with the first 14 days being the rapid release stage (releasing a total of 45.89% of the nutrient), followed by a slow-release stage (the nutrient release rate was only 50.29% until the day 84). The nitrogen release curve of the sulfonated lignin as a by-product of papermaking wood pulp/UF slow-release fertilizer showed a slow growth trend, with a release rate of 13.45% on day 1, when the nutrient was released rapidly; the nutrient release rate was slower from days 3 to 56, and the cumulative nitrogen release rate gradually reached 63.99%; the nutrient release rate further slowed down in the following 28 days, and reached 67.61% on day 84. The results of the hydrostatic release test of nitrogen indicated that the present method successfully improved the nutrient release rate of UF fertilizer in the middle and late stages.

The foregoing are merely specific embodiments of the present application to enable those skilled in the art to understand or complement this application. Although the disclosure has been described in detail above with reference to the embodiments, it should be understood by one of ordinary skill in the art that various changes and modifications and equivalent replacements can still be made to the technical solutions in the preceding embodiments. Those changes, modifications, and replacements made without departing from the spirit of the disclosure should fall within the scope of the disclosure defined by the appended claims.

What is claimed is:

1. A sulfonated lignin as a by-product of papermaking wood pulp/urea formaldehyde (UF) fertilizer, wherein the sulfonated lignin/urea formaldehyde (UF) fertilizer has structures represented by: 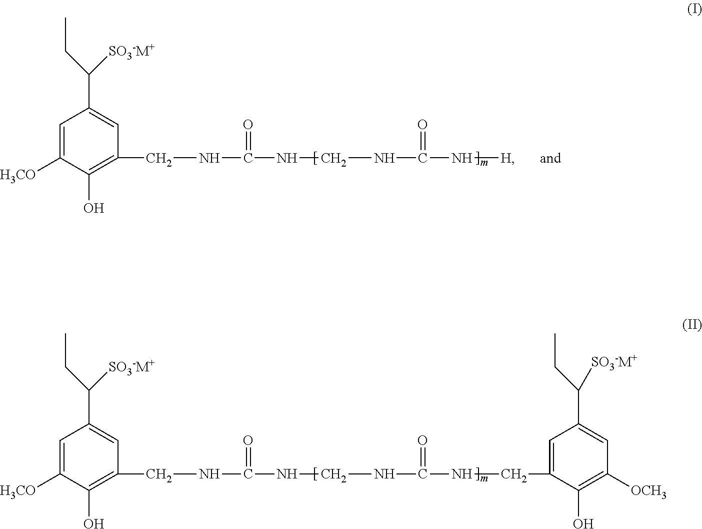
wherein M⁺ is K⁺, Na⁺, or NH₄⁺; and m is selected from 1-5.

2. A method of preparing the sulfonated lignin as a by-product of papermaking wood pulp/UF fertilizer, comprising:
(1) adding formaldehyde, sulfonated lignin, and water to a first reactor to obtain a first mixture; and adjusting a pH of the first mixture followed by a reaction to obtain a hydroxymethylated sulfonated lignin solution;
(2) sequentially adding formaldehyde and urea to a second reactor to obtain a second mixture; and adjusting a pH of the second mixture followed by a reaction to obtain a hydroxymethyl-urea solution;
(3) sealing a die opening between a reaction unit and an extrusion unit of a reaction-extrusion integrated machine; mixing the hydroxymethylated sulfonated lignin solution obtained in step (1) and the hydroxymethyl-urea solution obtained in step (2) to obtain a third mixture; and adjusting a pH of the third mixture followed by feeding to a twin-screw reaction extruder of the reaction unit of the reaction-extrusion integrated machine;
(4) turning on a screw of the twin-screw reaction extruder, and simultaneously starting a vacuumization-de-volatilization device of the twin-screw reaction extruder to remove water from the third mixture; and reacting the third mixture at a preset temperature and a preset screw rotation speed for a preset time to obtain a viscous reaction product;
(5) opening the die opening between the reaction unit and the extrusion unit, and starting a twin-screw extruder of the extrusion unit such that the viscous reaction product obtained in step (4) is conveyed by the twin-screw reaction extruder of the reaction unit to the twin-screw extruder of the extrusion unit; and subjecting the viscous reaction product to extrusion at a preset temperature and a preset screw rotation speed to obtain a strip product; and
(6) drying the strip product obtained in step (5) at a preset temperature followed by granulation to obtain the sulfonated lignin as a by-product of papermaking wood pulp/UF fertilizer in a form of a columnar particle.

3. The method of claim 2, wherein in step (1), a molar ratio of the formaldehyde to the sulfonated lignin is 1.1˜1.7:1, and a weight ratio of the sulfonated lignin to the water is 6:7; the first mixture is adjusted to pH 10˜14; and the reaction is performed at 40° C.˜70° C. for 1 —2 h.

4. The method of claim 2, wherein in step (2), a molar ratio of urea to formaldehyde is 1˜2:1; the second mixture is adjusted to pH 8˜10; and the reaction is performed at 40° C.˜80° C. for 1˜2 h.

5. The method of claim 2, wherein in step (3), a weight ratio of hydroxymethyl-urea in the hydroxymethyl-urea solution to hydroxymethylated sulfonated lignin in the hydroxymethylated sulfonated lignin solution is 1˜9:1, and the third mixture is adjusted to pH 3˜5.

6. The method of claim 2, wherein in step (4), the preset temperature is 80° C.˜120° C.; the preset time is 20˜50 min; and the preset screw rotation speed is 10˜50 rpm.

7. The method of claim 2, wherein in step (5), the preset temperature is 80° C.˜120° C.; and the preset screw rotation speed is 10˜50 rpm.

8. The method of claim 2, wherein in step (6), the strip product is dried at 40° C.˜120° C.
